(19) United States
(12) Patent Application Publication
(10) Pub. No.: US 2018/0058261 A1
(43) Pub. Date: Mar. 1, 2018

(54) Turbine

(71) Applicant: Mitsubishi Hitachi Power Systems, Ltd., Nishi-ku (JP)

(72) Inventors: Shigeki SENOO, Yokohama (JP); Hisataka FUKUSHIMA, Yokohama (JP)

(21) Appl. No.: 15/643,500

(22) Filed: Jul. 7, 2017

(30) Foreign Application Priority Data
Aug. 29, 2016 (JP) 2016-166385

(51) Int. Cl. F01D 25/24; F01D 1/04; F01D 5/22; F01D 9/04

(52) U.S. Cl. CPC F01D 25/24; F01D 1/04; F05D 2220/31; F01D 9/041; F01D 5/225

(57) ABSTRACT

A turbine includes a turbine rotor, a stationary body that covers the turbine rotor, and a diffuser provided on an outlet side of the stationary body. Last-stage moving blades of the turbine rotor include blade sections and covers provided at distal ends of the blade sections. The diffuser is formed such that an outer circumferential surface of an inlet section is small in diameter with respect to an inner circumferential surface of an outlet section of the stationary body and a circumferential wall section of the inlet section at least partially overlaps the covers in a radial direction when viewed from the axial direction. An annular gap space between the stationary body and the covers faces a space on an outer side of an outer circumferential surface of the diffuser when viewed from the axial direction.

### BACKGROUND OF THE INVENTION

### Field of the Invention

The present invention relates to a turbine.

### Background Art

A moving blade at a last stage (hereinafter, last-stage moving blade) of a low-pressure turbine tends to be elongated in order to meet requests fora high output and high efficiency of turbines in recent years (see JP-A-2003-65002 and the like).

### SUMMARY OF THE INVENTION

When the last-stage moving blade is elongated, the circumferential speed of the last-stage moving blade increases. In order to obtain a large stage heat drop proportionate to the increased circumferential speed, it is necessary to raise the pressure of working fluid on an upstream side in a flowing direction (hereinafter, upstream side) of the working fluid of the last-stage moving blade. On the other hand, the pressure of the working fluid on a downstream side in the flowing direction (hereinafter, downstream side) of the working fluid of the last-stage moving blade is generally determined by the pressure in a condenser disposed on the downstream side of the turbine. Therefore, when the pressure of the working fluid present on the upstream side of the last-stage moving blade is raised, a ratio of an upstream pressure with respect to a downstream pressure of the working fluid of the last-stage moving blade increases.

Incidentally, in the turbine, there is a gap between a moving blade of a turbine rotor, which is a rotating body, and a stationary body that covers the turbine rotor. A part of the working fluid present on the upstream side of the last-stage moving blade can pass the gap. A flow passing the gap between a moving blade distal end and the stationary body opposed to the moving blade distal end without passing a blade section (a profile section) of the moving blade in this way is described as leak flow in this specification. The leak flow is sometimes suppressed by providing a seal fin on opposed surfaces of the moving blade distal end and the stationary body. However, even in this case, a very small gap remains between a seal fin distal end and a section opposed to the seal fin distal end. The leak flow cannot be completely suppressed.

When the ratio of the upstream pressure with respect to the downstream pressure of the last-stage moving blade increases as explained above and a ratio of pressures of the leak flow in front of and behind the seal fin exceeds a critical pressure ratio, the leak flow flows out from the very small gap at supersonic speed. In general, in a supersonic flow, contrary to a subsonic flow, flow velocity increases and pressure drops according to an increase in a sectional area of the flow. Therefore, in the supersonic leak flow, flow velocity increases in the portion of a diffuser provided such that the sectional area of the flow increases in order to reduce the subsonic flow of a main flow. A shock wave occurs and the supersonic leak flow changes to the subsonic flow further downstream of the diffuser. At this point, the pressure of the leak flow dropped according to the seal fin passage suddenly rises with the shock wave (a discontinuous change in pressure) in the diffuser. When a wall surface boundary layer flow with low flow velocity flowing near a diffuser wall surface passes through the shock wave, the leak flow separates from the diffuser wall surface. It is likely that a channel area enlargement effect of the diffuser decreases, pressure recovery performance is deteriorated, and a pressure loss increases.

The present invention has been devised in view of the above and an object of the present invention is to provide a turbine that can suppress an increase in a pressure loss due to separation of a leak flow from a diffuser wall surface.

In order to achieve the object, the present invention is a turbine including: a turbine rotor formed by providing, in an axial direction, a plurality of stages of moving blade rows including pluralities of moving blades arranged in a circumferential direction; a stationary body that covers the turbine rotor; and a diffuser provided on an outlet side of the stationary body. Last-stage moving blades of the turbine rotor include blade sections and covers provided at distal ends of the blade sections. The covers of the blade sections adjacent to one another are coupled to configure an annular shape. The diffuser is formed such that an outer circumferential surface of an inlet section is small in diameter with respect to an inner circumferential surface of an outlet section of the stationary body and a circumferential wall section of the inlet section at least partially overlaps the covers in a radial direction when viewed from the axial direction. An annular gap space between the stationary body and the covers faces a space on an outer side of an outer circumferential surface of the diffuser when viewed from the axial direction.

According to the present invention, it is possible to suppress an increase in a pressure loss due to separation of a leak flow from a diffuser wall surface.

### BRIEF DESCRIPTION OF THE DRAWINGS

FIG. 1 is a schematic diagram showing the overall configuration of a configuration example of a steam turbine power generation facility including a low-pressure turbine according to an embodiment of the present invention;

FIG. 2 is a sectional view showing the internal structure of a main part of the low-pressure turbine according to the embodiment of the present invention;

FIG. 3 is a perspective view showing the schematic configuration of a last-stage moving blade included in the low-pressure turbine according to the embodiment of the present invention;

FIG. 4 is a perspective view showing a state in which the last-stage moving blade included in the low-pressure turbine according to the embodiment of the present invention is fixed to a rotor disk;

FIG. 5 is a diagram in which FIG. 4 is viewed from a radial direction outer side;

FIG. 6 is a partially enlarged view showing an outlet section of an inner stationary body included in the low-pressure turbine according to the embodiment of the present invention; and

FIG. 7 is a partially enlarged view showing an outlet section of an inner stationary body included in a low-pressure turbine according to a comparative example.

### DESCRIPTION OF THE PREFERRED EMBODIMENTS

### Configuration

### 1. Steam Turbine Power Generation Facility

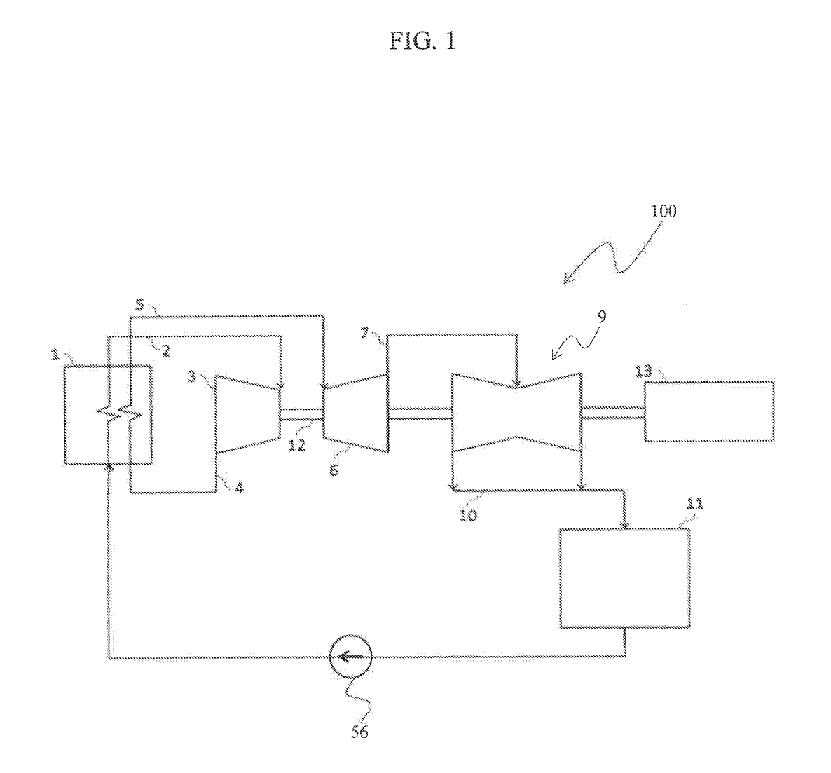

FIG. 1 is a schematic diagram showing the overall configuration of a configuration example of a steam turbine power generation facility including a low-pressure turbine according to an embodiment of the present invention. As shown in FIG. 1, a steam turbine power generation facility 100 includes a steam generation source 1, a high-pressure turbine 3, an intermediate-pressure turbine 6, a low-pressure turbine 9, a condenser 11, and a load apparatus 13.

The steam generation source (a boiler) 1 heats feed water supplied from the condenser 11 and generates high-temperature/high-pressure steam. The steam generated by the boiler 1 is guided to the high-pressure turbine 3 via a main steam pipe 2 and drives the high-pressure turbine 3. The steam that has driven the high-pressure turbine 3 and has been decompressed flows down in a high-pressure turbine exhaust pipe 4 and is guided to the boiler 1 and heated again to be reheated steam.

The reheated steam heated by the boiler 1 is guided to the intermediate-pressure turbine 6 via a reheating steam pipe 5 and drives the intermediate-pressure turbine 6. The steam that has driven the intermediate-pressure turbine 6 and has been decompressed is guided to the low-pressure turbine 9 via an intermediate-pressure turbine exhaust pipe 7 and drives the low-pressure turbine 9. The steam that has driven the low-pressure turbine 9 and has been decompressed flows in a diffuser 10 and is guided to the condenser 11. The condenser 11 includes a cooling water pipe (not shown in the figure). The condenser 11 causes the steam guided to the condenser 11 and cooling water flowing in the cooling water pipe to perform heat exchange and condenses the steam. The condensed water generated by the condenser 11 is sent to the boiler 1 again as feed water by a feed water pump 56.

The high-pressure turbine 3, the intermediate-pressure turbine 6, and the low-pressure turbine 9 are coupled on the same axis by a turbine rotor 12. The load apparatus (in this embodiment, a generator) 13 is coupled to the turbine rotor 12. The generator 13 is driven by rotation power of the high-pressure turbine 3, the intermediate-pressure turbine 6, and the low-pressure turbine 9. The rotation power of the high-pressure turbine 3, the intermediate-pressure turbine 6, and the low-pressure turbine 9 is converted into electric power.

In this embodiment, the configuration is illustrated in which the coupled high-pressure turbine 3, intermediate-pressure turbine 6, and low-pressure turbine 9 drive the generator 13. However, a configuration may be adopted in which the high-pressure turbine 3, the intermediate-pressure turbine 6, and the low-pressure turbine 9 respectively drive generators and individually convert rotation power into electric power or a configuration may be adopted in which a turbine obtained by coupling any two of the high-pressure turbine 3, the intermediate-pressure turbine 6, and the low-pressure turbine 9 drives a generator and converts rotation power into electric power. The configuration including the high-pressure turbine 3, the intermediate-pressure turbine 6, and the low-pressure turbine 9 is illustrated. However, a configuration excluding the intermediate-pressure turbine 6 and including the high-pressure turbine 3 and the low-pressure turbine 9 may be adopted. Further, the configuration including the boiler as the steam generation source 1 is illustrated. However, a configuration including, as the steam generation source 1, a heat recovery steam generator (HRSG) that uses exhaust heat of a gas turbine may be adopted. That is, the steam turbine power generation facility may be a combined cycle power generation facility. The steam generation source 1 may be an atomic power generation facility including an atomic reactor.

### 2. Steam Turbine

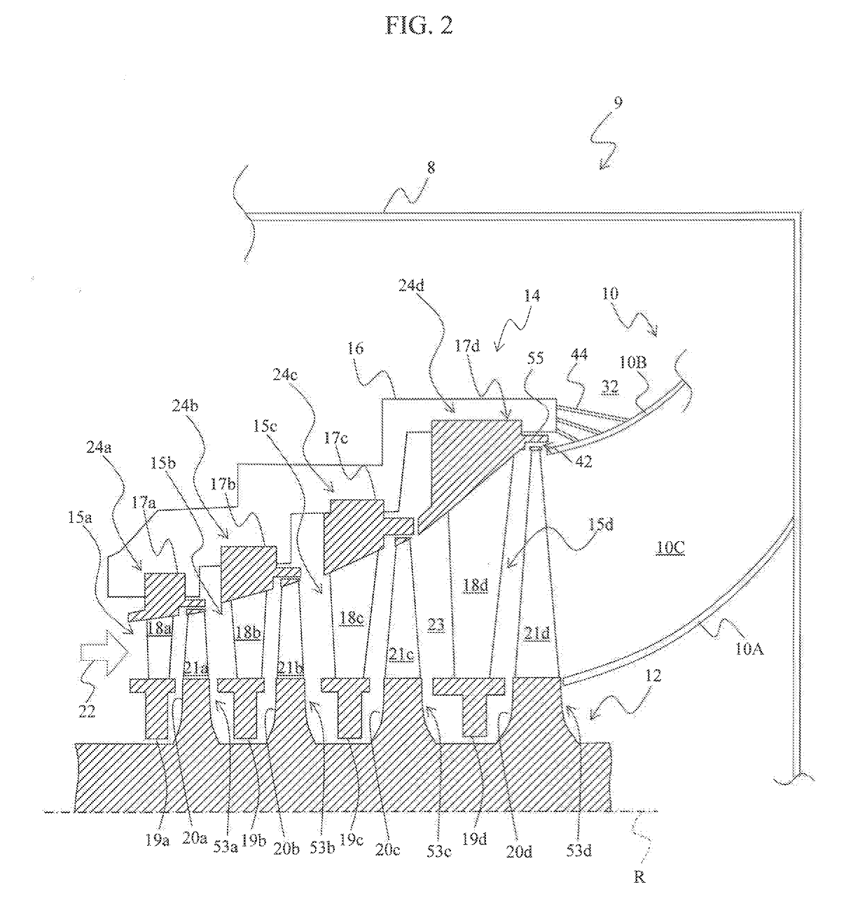

FIG. 2 is a sectional view showing the internal structure of a main part of the low-pressure turbine 9 according to the embodiment of the present invention. As shown in FIG. 2, the low-pressure turbine 9 includes the turbine rotor 12, an inner stationary body 14, the diffuser 10, and an outer stationary body 8. Note that, in this specification, a rotating direction and a rotation axis direction of the turbine rotor 12 are simply referred to as “rotating direction” and “rotation axis direction” and a radial direction inner side and a radial direction outer side of the turbine rotor 12 are simply referred to as “radial direction inner side” and “radial direction outer side”.

### Inner Stationary Body

The inner stationary body 14 is provided to cover the turbine rotor 12. The inner stationary body 14 includes a casing 16, outer diaphragms 17a to 17d, stationary blades 18a to 18d, and inner diaphragms 19a to 19d.

The casing 16 is a cylindrical member that forms the outer circumferential wall of the inner stationary body 14. In this embodiment, an outer circumferential wall section 10B of the diffuser 10 is connected to the end portion on a downstream side of the casing 16 via a supporting section 44 (explained below). The outer diaphragms 17a to 17d, the stationary blades 18a to 18d, the inner diaphragms 19a to 19d, and the turbine rotor 12 are housed in the casing 16.

The outer diaphragms 17a to 17d are supported on the inner circumferential surface of the casing 16. The outer diaphragms 17a to 17d are cylindrical members extending in the rotating direction. In this embodiment, the outer diaphragms 17a to 17d are configured by combining members formed in a semicircular shape. The outer diaphragms 17a to 17d are formed such that the inner circumferential surfaces thereof spread to the radial direction outer side toward the downstream side. Note that, in this embodiment, the configuration is illustrated in which the outer diaphragms 17a to 17d are respectively supported on the inner circumferential surface of the casing 16. However, a configuration may be adopted in which the outer diaphragms 17a to 17d are integrally formed and supported on the inner circumferential surface of the casing 16.

The stationary blades 18a to 18d are provided in plurality along the rotating direction on the inner circumferential surfaces of the outer diaphragms 17a to 17d. The stationary blades 18a to 18d are provided to extend from the inner circumferential surfaces of the outer diaphragms 17a to 17d toward the radial direction inner side.

The inner diaphragms 19a to 19d are provided on the radial direction inner side of the outer diaphragms 17a to 17d. The inner diaphragms 19a to 19d are cylindrical members extending in the rotating direction. In this embodiment, the inner diaphragms 19a to 19d are configured by combining members formed in a semicircular shape. The stationary blades 18a to 18d are connected to the outer circumferential surfaces of the inner diaphragms 19a to 19d. That is, the stationary blades 18a to 18d are fixed between the outer diaphragms 17a to 17d and the inner diaphragms 19a to 19d.

In this embodiment, the outer diaphragm 17a, the stationary blade 18a, and the inner diaphragm 19a configure a stationary blade row 15a at a first stage, the outer diaphragm 17b, the stationary blade 18b, and the inner diaphragm 19b configure a stationary blade row 15b at a second stage, the outer diaphragm 17c, the stationary blade 18c, and the inner diaphragm 19c configure a stationary blade row 15c at a third stage, and the outer diaphragm 17d, the stationary blade 18d, and the inner diaphragm 19d configure a stationary blade row 15d at a fourth stage (a last stage).

An annular space formed between the inner diaphragms 19a to 19d and platforms (explained below) of moving blades 21a to 21d and the outer diaphragms 17a to 17d and covers (explained below) configures a channel (an annular channel) 23 in which working fluid 22 flows. The inner circumferential wall of the annular channel 23 is formed by the outer circumferential surfaces of the inner diaphragms 19a to 19d and the outer circumferential surfaces of the platforms of the moving blades 21a to 21d. The outer circumferential wall of the annular channel 23 is formed by the inner circumferential surfaces of the outer diaphragms 17a to 17d and surfaces facing the radial direction inner side of the covers.

### Turbine Rotor

The turbine rotor 12 includes rotor disks 20a to 20d and the moving blades 21a to 21d.

The rotor disks 20a to 20d are disk-like members disposed side by side in the rotation axis direction. The rotor disks 20a to 20d are sometimes alternately superimposed with spacers (not-shown in the figure).

The moving blades 21a to 21d are respectively provided on the outer circumferential surfaces of the rotor disks 20a to 20d in plurality at equal intervals along the rotating direction. The moving blades 21a to 21d are provided to extend from the outer circumferential surfaces of the rotor disks 20a to 20d toward the radial direction outer side. The moving blades 21a to 21d are rotated round a rotation axis R together with the rotor disks 20a to 20d by the working fluid 22 flowing in the annular channel 23.

In this embodiment, the rotor disk 20a and the moving blade 21a configure a moving blade row 53a at the first stage, the rotor disk 20b and the moving blade 21b configure a moving blade row 53b at the second stage, the rotor disk 20c and the moving blade 21c configure a moving blade row 53c at the third stage, and the rotor disk 20d and the moving blade 21d configure a moving blade row 53d at the fourth stage (the last stage).

The stationary blades 18a to 18d and the moving blades 21a to 21d are alternately provided in the rotation axis direction in the order of the stationary blade 18a, the moving blade 21a, the stationary blade 18b, the moving blade 21b, and the like from an inlet side (a most upstream side) of the working fluid 22 of the inner stationary body 14 toward the downstream side. The stationary blades 18a to 18d are disposed to be opposed to the moving blades 21a to 21d in the rotation axis direction.

From the inlet side of the working fluid 22 of the inner stationary body 14, one set of a stationary blade row and a moving blade row adjacent to each other in the rotation axis direction configures a blade stage. In this embodiment, the stationary blade row 15a at the first stage and the moving blade row 53a at the first stage configure a first blade stage 24a, the stationary blade row 15b at the second stage and the moving blade row 53b at the second stage configure a second blade stage 24b, the stationary blade row 15c at the third stage and the moving blade row 53c at the third stage configure a third blade stage 24c, and the stationary blade row 15d at the fourth stage and the moving blade row 53d at the fourth stage configure a fourth blade stage 24d. The fourth blade stage 24d is a last stage disposed on the outlet side of the working fluid 22 of the inner stationary body 14. The fourth blade stage 24d is disposed in a position closest to the diffuser 10. Blade lengths (lengths in the radial direction) of the moving blades 21a to 21d disposed in the first to fourth blade stages are formed to be larger in the moving blades located further on the downstream side. The blade length of the moving blade (the last-stage moving blade) 21d disposed in the fourth blade stage 24d is formed larger than the blade lengths of the moving blades 21a to 21c (formed longest among the moving blades 21a to 21d). Specifically, the last-stage moving blade 21d has the blade length at which a moving blade distal end circumferential speed Mach number obtained by dividing the rotation circumferential speed of the distal end portion of a blade section 26 (explained below) by the sonic speed of the working fluid 22 flowing at the distal end portion of the blade section 26 exceeds 1.0 during the rotation of the turbine rotor 12.

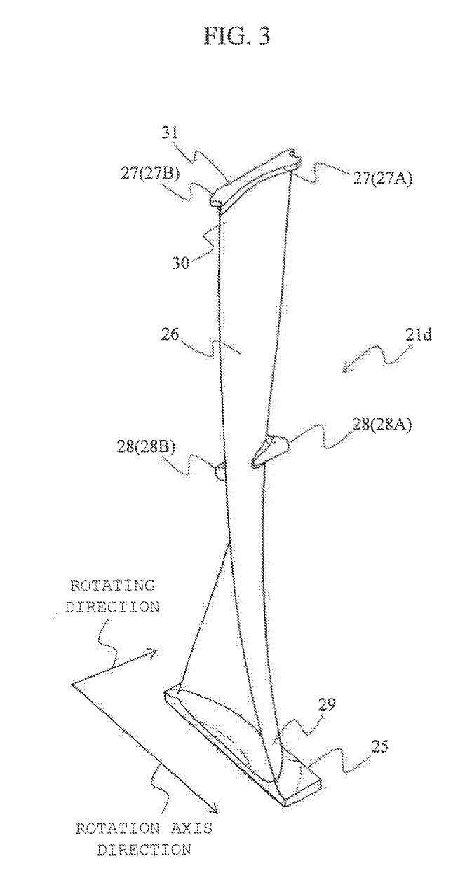

FIG. 3 is a perspective view showing the schematic configuration of the last-stage moving blade 21d. As shown in FIG. 3, the last-stage moving blade 21d includes a platform 25, the blade section 26, an integral cover 27, and a tie boss 28.

The platform 25 has size for covering the entire end face of a root portion (a portion on the radial direction inner side) 29 of the blade section 26. In this embodiment, the platform 25 is formed in a lozenge shape when viewed from the radial direction outer side. A blade root attachment (not shown in the figure) projecting to the opposite side of the blade section 26 is provided on the lower surface (a surface facing the radial direction inner side) of the platform 25. The blade root attachment is formed in, for example, a reverse Christmas tree shape. The blade root attachment is fit with a groove section (not shown in the figure) formed on the outer circumferential surface of the rotor disk 20d (see FIG. 2), whereby the last-stage moving blade 21d is fixed to the rotor disk 20d. Note that, in the illustration in this embodiment, the blade root attachment is formed in the reverse Christmas tree shape. However, the shape of the blade root attachment is not limited to the reverse Christmas tree shape as long as the blade root attachment can be fit with the groove section formed on the outer circumferential surface of the rotor disk 20d and can fix the last-stage moving blade 21d to the rotor disk 20d resisting a centrifugal force generated during the rotation of the turbine rotor 12.

The blade section 26 is attached to the outer circumferential surface of the platform 25 and extends from the outer circumferential surface of the platform 25 to the radial direction outer side. The blade section 26 is formed to be twisted.

The integral cover (the cover) 27 is provided at a distal end portion (an end portion in the radial direction outer side) 30 of the blade section 26. The cover 27 includes a suction side integral cover (a first cover) 27A extending in the rotating direction in a suction side section of the last-stage moving blade 21d and a pressure side integral cover (a second cover) 27B extending in the rotating direction in a pressure side section of the last-stage moving blade 21d. As explained above, the surface of the cover 27 facing the radial direction inner side configures a part of the outer circumferential wall of the annular channel 23 and defines the annular channel 23. The cover 27 comes into contact with covers of last-stage moving blades (adjacent blades) adjacent to each other on both sides in the rotating direction of the last-stage moving blade 21d during the rotation of the turbine rotor 12 and couples the last-stage moving blade 21d and the adjacent blades to configure an annular shape. Action of the cover 27 during the rotation of the turbine rotor 12 is explained below.

When the last-stage moving blade 21d is assembled to the low-pressure turbine 9, when viewed on a cross section cut along a plane including the rotation axis R of the turbine rotor 12 (hereinafter referred to as meridional plane cross section), the cover 27 includes a surface opposed to the inner circumferential surface of the outer diaphragm 17d (the stationary body 14) and extending in the rotation axis direction. In this specification, the surface facing the radial direction outer side of the cover 27 and opposed to the inner circumferential surface of the outer diaphragm 17d is described as a moving blade distal end face 31 for convenience. In this embodiment, the moving blade distal end face 31 is formed in size for covering the entire end face of the distal end portion 30 of the last-stage moving blade 21d. That is, when the last-stage moving blade 21d is assembled to the low-pressure turbine 9, when viewed on the meridional plane cross section, the length in the rotation axis direction of the moving blade distal end face 31 is set larger than the length in the rotation axis direction of the blade section 26 at the distal end portion 30 of the last-stage moving blade 21d. A gap space 42 that causes spaces on upstream and downstream sides of the last-stage moving blade 21d to communicate is present between the moving blade distal end face 31 and the inner circumferential surface of the outer diaphragm 17d (see FIG. 2).

The tie boss 28 is provided between the root portion 29 and the distal end portion 30 of the blade section 26. In this embodiment, the tie boss 28 is provided in an intermediate portion in the radial direction of the blade section 26. The tie boss 28 includes a suction side tie boss (a first tie boss) 28A provided on the suction side of the last-stage moving blade 21d and a pressure side tie boss (a second tie boss) 28B provided on the pressure side of the last-stage moving blade 21d. The tie boss 28 comes into contact with a tie boss of an adjacent blade during the rotation of the turbine rotor 12 and couples the last-stage moving blade 21d and the adjacent blade. Action of the tie boss 28 during the rotation of the turbine rotor 12 is explained below. Note that, in the illustration in this embodiment, the tie boss 28 is provided in the intermediate portion in the radial direction of the blade section 26. However, the tie boss 28 may be shifted to the radial direction inner side or the radial direction outer side from the intermediate portion of the blade section 26 according to, for example, torsional rigidity of the blade section 26.

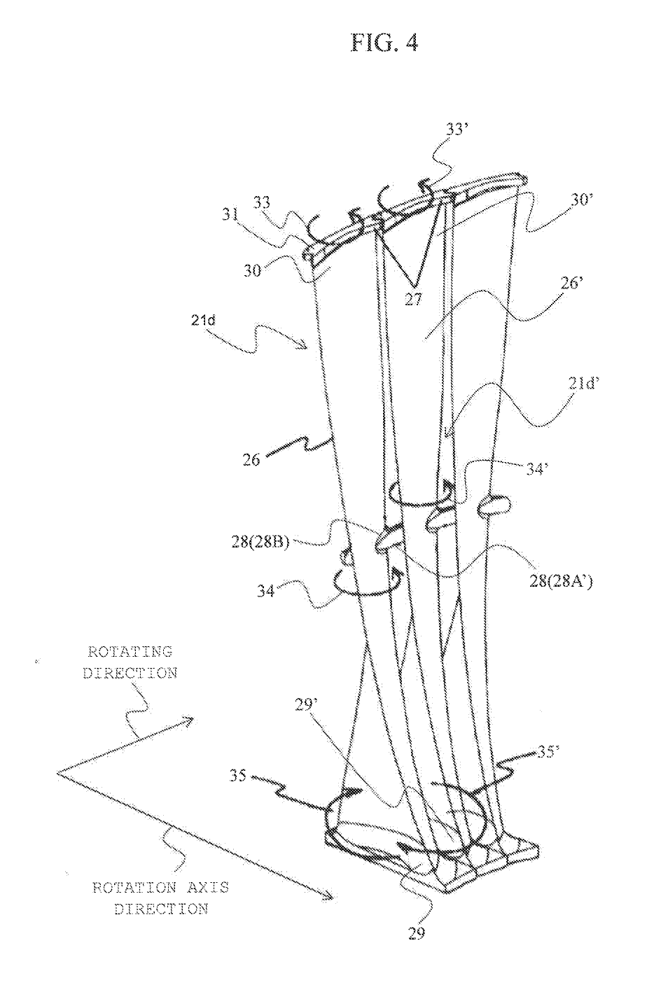

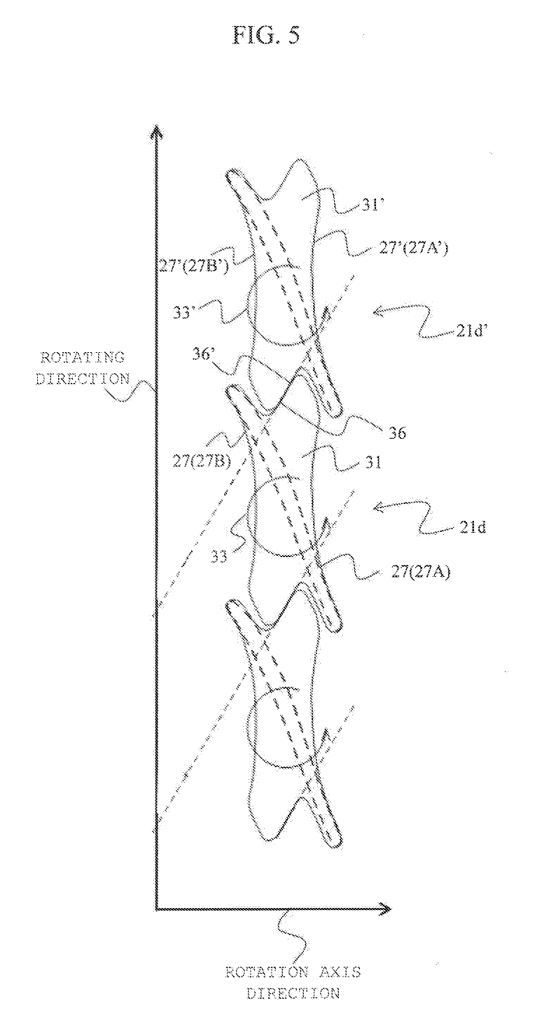

FIG. 4 is a perspective view showing a state in which the last-stage moving blade 21d is fixed to the rotor disk 20d. FIG. 5 is a diagram in which FIG. 4 is viewed from the radial direction outer side. Note that, in FIG. 4, the rotor disk 20d is omitted.

According to an increase of the rotating speed of the turbine rotor 12, a centrifugal force acts on the blade section 26 of the last-stage moving blade 21d from the root portion 29 toward the distal end portion 30. Since the blade section 26 is twisted as explained above, untwist is caused in the blade section 26 by the centrifugal force. Consequently, as shown in FIG. 4, an untwist moment 33 acts on the distal end portion 30 of the blade section 26, an untwist moment 34 acts on the intermediate portion of the blade section 26, and an untwist moment 35 acts on the root portion 29 of the blade section 26 respectively in directions indicated by arrows. Similarly, an untwist moment 33′ acts on a distal end portion 30′ of a blade section 26′ of a last-stage moving blade 21d′ adjacent to the last-stage moving blade 21d in the rotating direction, an untwist moment 34′ acts on the intermediate portion of the blade section 26′, and an untwist moment 35′ acts on a root portion 29′ of the blade section 26′ respectively in directions indicated by arrows.

As shown in FIG. 5, in this embodiment, when the last-stage moving blade 21d is assembled to the low-pressure turbine 9, when viewed from the radial direction outer side, an end face 36 on the downstream side in the rotating direction of the first cover 27A of the last-stage moving blade 21d and an end face 36′ on the upstream side in the rotating direction of a second cover 27B′ of the last-stage moving blade 21d′ restrict the untwist moments 33 and 33′ during the rotation of the turbine rotor 12. The second tie boss 28B of the last-stage moving blade 21d and a first tie boss 28A′ of the last-stage moving blade 21d′ restrict the untwist moments 34 and 34′. Consequently, during the rotation of the turbine rotor 12, the end face 36 and the end face 36′ come into surface contact with each other, the second tie boss 28B and the first tie boss 28A′ come into surface contact with each other, and the last-stage moving blades 21d and 21d′ are coupled in the rotating direction.

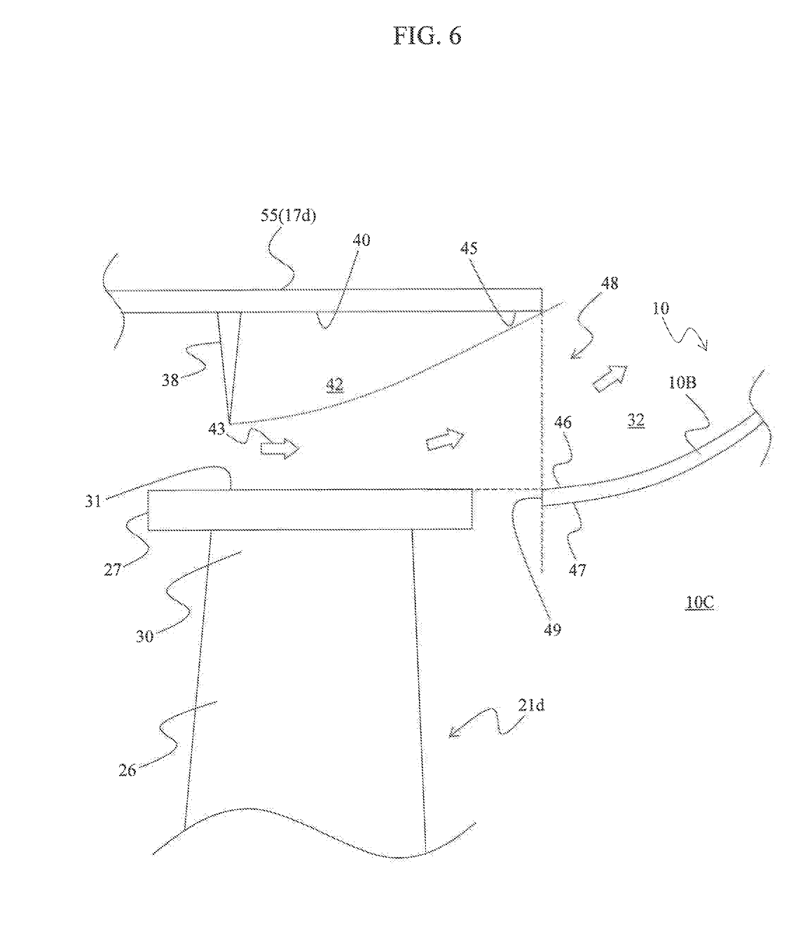

FIG. 6 is a partially enlarged view showing an outlet section of the inner stationary body 14 (the outer diaphragm 17d).

In this embodiment, when the last-stage moving blade 21d is assembled to the low-pressure turbine 9, as shown in FIG. 6, when viewed on the meridional plane cross section, a seal fin 38 is provided on a surface of a projecting section 55 of the outer diaphragm 17d opposed to the last-stage moving blade 21d (a seal fin is not provided on the moving-blade distal end face 31 of the cover 27). In this specification, a portion extending in the rotation axis direction and opposed to the last-stage moving blade 21d on the inner circumferential surface of the projecting section 55 of the outer diaphragm 17d is described as a moving blade opposed surface 40 for convenience. Note that, in this embodiment, the configuration is illustrated in which the outer diaphragm 17d and the projecting section 55 are integrally formed. However, a configuration may be adopted in which the projecting section 55 is attached to the outer diaphragm 17d by welding or the like as an inner casing on the outer side of the last-stage moving blade 21d. When the last-stage moving blade 21d is assembled to the low-pressure turbine 9, when viewed on the meridional plane cross section, the seal fin 38 extends from the moving blade opposed surface 40 toward the last-stage moving blade 21d to suppress a leak flow 43 flowing in the gap space 42 between the cover 27 and the moving blade opposed surface 40. In other words, the last-stage moving blade 21d is disposed such that the distal end (the cover 27) of the last-stage moving blade 21d is opposed to the seal fin 38. In this embodiment, one seal fin 38 is provided in the rotation axis direction on the moving blade opposed surface 40. Avery small gap is present between the distal end portion (the end portion on the radial direction inner side) of the seal fin 38 and the moving blade distal end face 31 in order to avoid contact of the stationary body 14 and the turbine rotor 12.

### Diffuser

As shown in FIG. 2, the diffuser 10 is provided on the outlet side (the downstream side) of the inner stationary body 14. The diffuser 10 has a function of guiding working fluid (exhaust air), which has driven to rotate the turbine rotor 12, to the condenser 11 (see FIG. 1) while recovering pressure. That is, the diffuser 10 has a function of recovering the pressure of a subsonic flow, which exits the last-stage moving blade 21d, through an enlarged channel of the diffuser 10 to make it possible to drop a static pressure of a last-stage outlet and extract more energy from steam. The diffuser 10 includes an inner circumferential wall section 10A and the outer circumferential wall section 10B. The inner circumferential wall section 10A is a member having a conical surface shape that configures the inner circumferential surface of the diffuser 10. The outer circumferential wall section 10B is a member having a conical surface shape formed to cover the outer circumferential side of the inner circumferential wall section 10A. The outer circumferential wall section 10B configures the outer circumferential surface of the diffuser 10. An annular space formed between the inner circumferential wall section 10A and the outer circumferential wall section 10B configures a channel (a diffuser channel) 10C in which the working fluid 22, which has driven to rotate the turbine rotor 12, flows.

In this embodiment, the end portion on the downstream side of the inner circumferential wall section 10A of the diffuser 10 is connected to the wall surface of the outer stationary body 8. The outer circumferential wall section 10B of the diffuser 10 is connected to and supported at the end portion on the downstream side of the casing 16 via the supporting section 44. In this embodiment, the supporting section 44 is a bar-like member extending from the end portion on the downstream side of the casing 16 toward the outer circumferential wall section 10B of the diffuser 10. In this embodiment, the supporting section 44 is provided in plurality along the rotating direction. Note that, in this embodiment, the configuration is illustrated in which the outer circumferential wall section 10B of the diffuser 10 is connected to the end portion on the downstream side of the casing 16 via the supporting section 44. However, a configuration may be adopted in which the outer circumferential wall section 10B of the diffuser 10 is connected to the end portion on the downstream side of the outer diaphragm 17d.

As shown in FIG. 6, the diffuser 10 is formed such that an outer circumferential surface 46 of an inlet section (the upstream side end portion) of the outer circumferential wall section 10B is small in diameter with respect to an inner circumferential surface 45 of an outlet section (the downstream side end portion) of the inner stationary body 14 (the outer diaphragm 17d). That is, the diffuser 10 is formed such that the distance from the rotation axis R (see FIG. 2) of the turbine rotor 12 to the outer circumferential surface 46 of the inlet section of the outer circumferential wall section 10B is shorter than the distance from the rotation axis R to the inner circumferential surface 45 of the outlet section of the outer diaphragm 17d.

In this embodiment, the diffuser 10 is formed such that a circumferential wall section 49 of the inlet section of the outer circumferential wall section 10B at least partially overlaps the cover 27 in the radial direction when viewed from the rotation axis direction. That is, the diffuser 10 is formed such that at least a part of the circumferential wall section 49 of the inlet section of the outer circumferential wall section 10B is hidden by the cover 27 when viewed from the rotation axis direction. Note that the circumferential wall section 49 refers to a wall surface opposed to, in the rotation axis direction, the cover 27 of the last-stage moving blade 21d in the outer circumferential wall section 10B of the diffuser 10 when viewed on the meridional plane cross section when the last-stage moving blade 21d is assembled to the low-pressure turbine 9.

Further, in this embodiment, the diffuser 10 is formed such that the circumferential wall section 49 of the inlet section of the outer circumferential wall section 10B is located in a range of thickness in the radial direction of the cover 27 in the radial direction when viewed from the rotation axis direction. Specifically, the diffuser 10 is formed such that the outer circumferential surface 46 of the inlet section of the outer circumferential wall section 10B is located flush with the upper surface (a surface facing the radial direction outer side) of the cover 27 or on the radial direction inner side with respect to the upper surface when viewed from the rotation axis direction and an inner circumferential surface 47 of the inlet section of the outer circumferential wall section 10B is located flush with the lower surface (a surface facing the radial direction inner side) of the cover 27 or on the radial direction outer side with respect to the lower surface when viewed from the rotation axis direction. In the configuration illustrated in FIG. 6, the diffuser 10 is formed such that the outer circumferential surface 46 of the outer circumferential wall section 10B is located flush with the upper surface of the cover 27 when viewed from the axial direction and the inner circumferential surface 47 of the outer circumferential wall section 10B is located on the radial direction outer side with respect to the lower surface of the cover 27 when viewed from the radial direction.

An annular gap 48 extending in the rotating direction is formed between the inner circumferential surface 45 of the outlet section of the inner stationary body 14 (the outer diaphragm 17d) and the outer circumferential surface 46 of the outer circumferential wall section 10B of the diffuser 10. The gap 48 causes the gap space 42 and a space 32 on the outer side of the outer circumferential surface 46 of the outer circumferential wall section 10B of the diffuser 10 (hereinafter, a diffuser outer space) to communicate. The gap space 42 faces the diffuser outer space 32 when viewed from the rotation axis direction.

### Outer Stationary Body

As shown in FIG. 2, the outer stationary body 8 is provided to cover the inner stationary body 14, the turbine rotor 12, and the diffuser 10. The outer stationary body 8 forms the outer wall of the low-pressure turbine 9.

### Operation

### Concerning a Main Flow (a Flow Passing the Blade Section of the Moving Blade)

A main flow of the working fluid 22 flows into spaces among the stationary blades 18a of the stationary blade row 15a at the first stage, accelerates while turning along the shape of the stationary blades 18a, and flows out from the spaces among the stationary blades 18a. The main flow flowing out from the spaces among the stationary blades 18a flows into spaces among the moving blades 21a of the moving blade row 53a at the first stage disposed on the downstream side of the stationary blade row 15a at the first stage and drives to rotate the turbine rotor 12. The main flow flowing out from the spaces among the moving blades 21a flows into spaces among the stationary blades 18b of the stationary blade row 15b at the second stage disposed on the downstream side of the moving blade row 53a at the first stage. Thereafter, the main flow flows into the diffuser channel 10C from the outlet section of the inner stationary body 14 while repeating the turning by the stationary blades, imparting of an acceleration component, and the rotation driving of the moving blades.

### Concerning the Leak Flow

As shown in FIG. 6, a part of the working fluid 22 passes a very small gap present between the distal end portion of the seal fin 38 and the cover 27 and flows into the gap space 42 as the leak flow 43.

When the pressure of the working fluid 22 on the upstream side of the last-stage moving blade 21d is raised, the rotating speed of the last-stage moving blade 21d increases and the rotation circumferential speed of the distal end portion of the blade section 26 increases. For the working fluid to impart a rotation driving force to the moving blade, a stagnation pressure of a moving blade inlet needs to be larger as circumferential speed is larger. Therefore, when a ratio of pressures in front of and behind the seal fin 38 increases and a moving blade distal end circumferential speed Mach number obtained by dividing the rotation circumferential speed of the distal end portion of the blade section 26 by the sonic speed of the working fluid 22 flowing into the blade section 26 increases to exceed 1.0, it is highly likely that the ratio of pressures in front of and behind the seal fin 38 exceeds a critical pressure ratio at which the speed of the working fluid 22 increases to supersonic speed downstream of passage of the seal fin 38.

The supersonic leak flow 43 flowing on the downstream side of the seal fin 38 in the gap space 42 flows out from the outlet section of the inner stationary body 14 (the outer diaphragm 17d) and guided to the diffuser outer space 32 (in other words, a space on the inner side of the outer stationary body 8) passing through the gap 48. Thereafter, the leak flow 43 is gradually decelerated and is decelerated to be a subsonic speed flow in the diffuser outer space 32.

### Effect

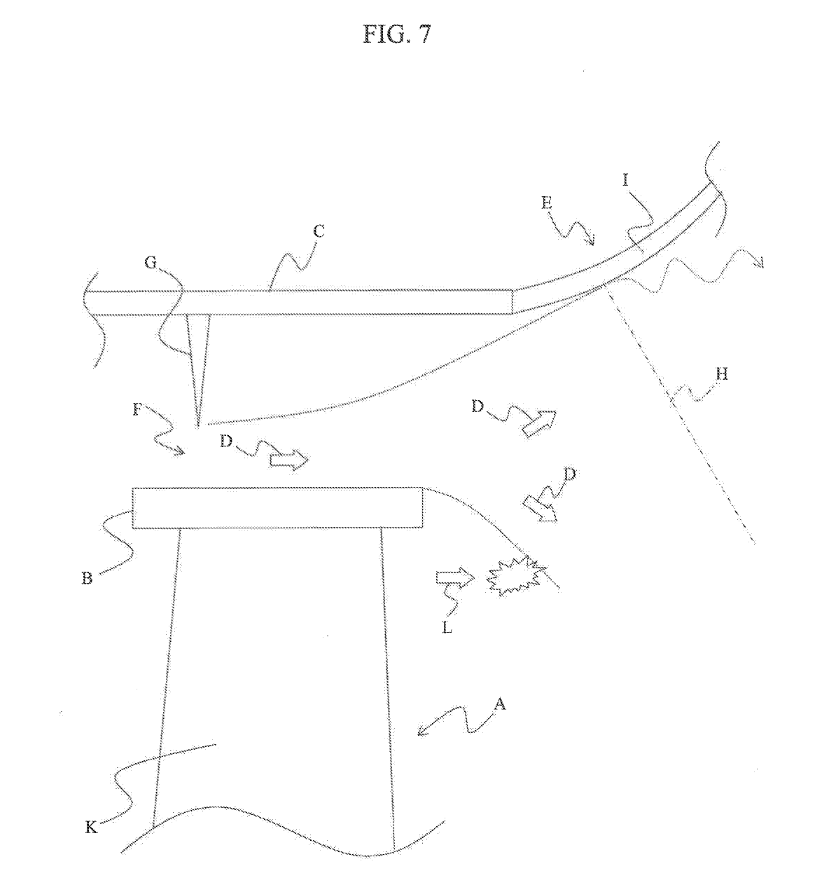

(1) FIG. 7 is a partially enlarged view showing an outlet section of an outer diaphragm according to a comparative example. As shown in FIG. 7, in the comparative example, an outer circumferential wall section I of a diffuser E is provided to be connected to the end face of an outlet section of an outer diaphragm C. In other words, the outer circumferential surface of the outer circumferential wall section I of the diffuser E is not formed to be small in diameter with respect to the inner circumferential surface of the outer diaphragm C. Therefore, a supersonic leak flow D passing a very small gap F present between the distal end portion of a seal fin G and a cover B and flowing in a gap present between the cover B and the outer diaphragm C increases in flow velocity and flows into the diffuser E and is thereafter changed to a subsonic flow while involving a total pressure loss by a shock wave. At this point, the pressure of the leak flow D dropped according to the seal fin passage suddenly rises because the leak flow D passes through a shock wave H in the diffuser E and has subsonic speed. When a wall surface boundary layer flow with low flow velocity flowing near a diffuser wall surface passes through the shock wave, the wall surface boundary layer flow separates from the wall surface of the diffuser E. It is likely that a channel area enlargement effect of the diffuser decreases, pressure recovery performance is deteriorated, and a pressure loss increases.

On the other hand, in this embodiment, as shown in FIG. 6, the diffuser 10 is formed such that the outer circumferential surface 46 of the outer circumferential wall section 10B is small in diameter with respect to the inner circumferential surface 45 of the outer diaphragm 17d. The gap 48 is provided between the inner circumferential surface 45 of the outer diaphragm 17d and the outer circumferential surface 46 of the outer circumferential wall section 10B. The gap space 42 faces the diffuser outer space 32 when viewed from the axial direction. Therefore, the supersonic leak flow 43 flowing on the downstream side of the seal fin 38 in the gap space 42 can be guided from the outlet section of the outer diaphragm 17d to the diffuser outer space 32 via the gap 48. Consequently, it is possible to prevent the supersonic leak flow 43 from flowing into the diffuser 10 to cause a shock wave in the diffuser 10. Therefore, it is possible to prevent a wall surface boundary layer flow with low flow velocity flowing near the outer circumferential wall section 10B of the diffuser 10 from separating from the outer circumferential wall section 10B of the diffuser 10. It is possible to suppress an increase in a pressure loss.

(2) As shown in FIG. 7, in a last-stage moving blade A according to the comparative example, a part of the supersonic leak flow D flowing in the diffuser E interferes with a main flow L flowing into the diffuser E passing through a blade section K of the last-stage moving blade A. An interference loss due to mixing of fluids having different velocities could occur. On the other hand, in this embodiment, as explained above, it is possible to guide the flow of the supersonic leak flow 43 to the diffuser outer space 32 via the gap 48. Therefore, it is possible to prevent the supersonic leak flow 43 from interfering with the main flow flowing into the diffuser 10 passing through the blade section 26 of the last-stage moving blade 21d.

(3) In this embodiment, the diffuser 10 is formed such that the circumferential wall section 49 of the inlet section of the outer circumferential wall section 10B is located within the range of the thickness in the radial direction of the cover 27 in the radial direction when viewed from the axial direction. Consequently, when viewed from the axial direction, the circumferential wall section 49 of the inlet section of the outer circumferential wall section 10B of the diffuser 10 does not project further to the radial direction outer side than the upper surface of the cover 27. Therefore, it is possible to prevent the supersonic leak flow 43 flowing on the downstream side of the seal fin 38 in the gap space 42 from interfering (colliding) with the circumferential wall section 49 of the inlet section of the outer circumferential wall section 10B of the diffuser 10 when the supersonic leak flow 43 passes the gap 48. It is possible to smoothly guide the supersonic leak flow 43 to the diffuser outer space 32.

### Others

The present invention is not limited to the embodiment explained above and includes various modifications. For example, the embodiment is explained in detail in order to clearly explain the present invention. The embodiment is not always limited to an embodiment including all the components explained above. For example, a part of the components of the embodiment can be deleted.

In the illustrations in the embodiment explained above, the outer diaphragm 17d is opposed to the cover 27. However, the essential effect of the present invention is to provide a moving blade that can suppress an increase in a pressure loss due to separation of a leak flow from a diffuser wall surface. The present invention is not always limited to the configuration explained above as long as the essential effect is obtained. A configuration may be adopted in which the member opposed to the cover 27 is the inner stationary body 14 and, for example, the casing 16 is opposed to the cover 27.

1. A turbine comprising:
a turbine rotor formed by providing, in an axial direction, a plurality of stages of moving blade rows including pluralities of moving blades arranged in a circumferential direction;
a stationary body that covers the turbine rotor; and
a diffuser provided on an outlet side of the stationary body, wherein
last-stage moving blades of the turbine rotor include blade sections and covers provided at distal ends of the blade sections, the covers of the blade sections adjacent to one another being coupled to configure an annular shape,
the diffuser is formed such that an outer circumferential surface of an inlet section is small in diameter with respect to an inner circumferential surface of an outlet section of the stationary body and a circumferential wall section of the inlet section at least partially overlaps the covers in a radial direction when viewed from the axial direction, and
an annular gap space between the stationary body and the covers faces a space on an outer side of an outer circumferential surface of the diffuser when viewed from the axial direction.

2. The turbine according to claim 1, wherein the diffuser is formed such that the circumferential wall section of the inlet section is located within a range of thickness in the radial direction of the covers in the radial direction when viewed from the axial direction.

3. A diffuser provided on an outlet side of a stationary body that covers a turbine rotor including, in an axial direction, a plurality of stages of moving blade rows including pluralities of moving blades arranged in a circumferential direction, wherein
the diffuser is formed such that an outer circumferential surface of an inlet section is small in diameter with respect to an inner circumferential surface of an outlet section of the stationary body, and
the diffuser is provided on the stationary body such that a circumferential wall section of the inlet section at least partially overlaps a covers provided at distal ends of blade sections of last-stage moving blades of the turbine rotor in a radial direction when viewed from the axial direction of the turbine rotor, and an annular gap space between the stationary body and the covers faces a space on an outer side of an outer circumferential surface of the diffuser when viewed from the axial direction of the turbine rotor.

4. The diffuser according to claim 3, wherein the diffuser is formed such that the circumferential wall section of the inlet section is located within a range of thickness in the radial direction of the covers in the radial direction when viewed from the axial direction.

5. A turbine comprising:
a turbine rotor formed by providing, in an axial direction, a plurality of stages of moving blade rows including pluralities of moving blades arranged in a circumferential direction; and
a stationary body that covers the turbine rotor, wherein
the diffuser according to claim 3 is provided on an outlet side of the stationary body.
